(19) United States
(12) Patent Application Publication
(10) Pub. No.: US 2014/0135191 A1
(43) Pub. Date: May 15, 2014

(54) PACKAGING MACHINE WITH A MEANS FOR ATTACHING AN INSERT TO A STRUCTURAL ELEMENT

(71) Applicants: Gerd Hübner, Wilnsdorf (DE); Klaus Meyer, Breidenbach (DE)

(72) Inventors: Gerd Hübner, Wilnsdorf (DE); Klaus Meyer, Breidenbach (DE)

(73) Assignee: GEA Food Solutions Germany GmbH, Biedenkopf-Wallau (DE)

(21) Appl. No.: 14/130,726

(22) PCT Filed: Jul. 6, 2012
(86) PCT No.: PCT/EP2012/063329

§ 371 Date: Jan. 31, 2014

(30) Foreign Application Priority Data
Jul. 6, 2011 (DE) 10 2011 107 277.6
Dec. 14, 2011 (DE) 10 2011 120 949.6

(51) Int. Cl. B31B 17/00

(52) U.S. Cl. CPC B31B 17/00
USPC 493/89

(57) ABSTRACT

The present invention relates to a packaging machine in which a film web is transported intermittently along a first transport direction and depressions are formed in the film web at the same time and these depressions are each joined in a connecting station to a structural element, the structural elements and/or a material web from which the structural elements are produced being transported along a second transport direction. The present invention further relates to a method for producing a package and to a package.

The present invention relates to a packaging machine in which a film web is intermittently conveyed along a first conveying direction, depressions being formed in the film web, and said depressions each being connected to a structural element in a connecting station, wherein the structural elements and/or a material web, from which the structural elements are produced, are conveyed along a second conveying direction. The present invention furthermore relates to a method for producing a pack, and to a pack.

Packaging machines of this type are known from the prior art. However, the packaging machines described there have the disadvantage of a comparatively low cycle speed.

It was therefore the object of the present invention to provide a packaging machine with which higher cycle speeds cam be implemented.

The object is achieved by a packaging machine in which a film web is intermittently conveyed along a first conveying direction, depressions being formed in the film web, and said depressions each being connected to a structural element in a connecting station, wherein the structural elements and/or a material web, from which the structural elements are produced, are conveyed along a second conveying direction, wherein the first and second conveying directions, in the region of the connecting station, are provided parallel to one another.

The observations made in the context of this subject matter of the present invention apply equally to the other subjects of the present invention, and vice versa.

The present invention relates to a packaging machine in which a film web is intermittently, i.e. cyclically, conveyed along a first conveying direction along the packaging machine. While the film web is at a standstill, the depressions are formed, in particular by thermoforming, in the film web. For this purpose, the film web, as a rule, is heated. A multiplicity of depressions, what is referred to as an X-Y-format of depressions, is preferably formed in the film web in one cycle. Thereafter, the film web is conveyed onward. Prior to, during or after the forming operation, the depressions are connected, according to the invention, to a structural element in a connecting station. This is in particular an integral connection and takes place preferably by sealing. In this manner, the connection is preferably easily releasable from the structural element, such that said connection and said structural element can be readily separated from one another, preferably without any significant damage, after the pack has been used.

The structural element may be produced from any material known to a person skilled in the art. The material of the depression and the material of the structural element are preferably different. The structural element may have paper, paperboard, cardboard, plastic, metal, in particular aluminum, or be produced from a composite made up of two or more of these materials. The structural element is preferably folded and/or is assembled from a plurality of parts. In another preferred embodiment, the structural element is produced from a planar material by plastic deformation. As a rule, the structural element is composed of a wall portion and a base. The wall portion is preferably provided so as to taper at least partially toward the base. The connection points between the depression and the structural element are in the region of the wall portion, on the base and/or on a periphery provided on the structural element. Connecting a depression to a structural element may take place while the film web is at a standstill or is being conveyed onward. The structural elements may be connected to the depressions of the film web individually or as a composite made up of a plurality of structural elements, it being particularly preferable for a plurality of individual packaging depressions to be connected simultaneously to a respective depression. A composite made up of structural elements has the advantage ox being easier to handle, it being necessary to singularize said composite at a later point in time.

The structural element imparts mainly the necessary mechanical properties to the packaging depression. The insert ensures in particular that the food is preserved and/or protected and/or protects the structural element. However, the structural element may also serve as insulation, in particular when the contents of the pack have been heated.

The insert may be any type of plastic film, in particular a film which is suitable for the foodstuffs industry. Said film, according to the invention, is connected to a structural element.

According to the invention, then, it is provided that the film web is conveyed along a first conveying direction and the prefabricated structural elements or the material web in which the packaging depressions are formed are conveyed along a second conveying direction to the connecting station, wherein these two conveying directions, at least in the region of the connecting station, are provided substantially parallel to one another. The structural elements are preferably conveyed below the film web in the direction of the connecting station. The conveying directions preferably do not intersect one another.

The depressions and the structural elements are connected to one another in the connecting station. In a preferred embodiment, the operations of forming the depressions and connecting the depressions to the structural elements take place in one station, the depression preferably being formed first and then being connected to the structural element. This particularly preferably takes place with a tool, for example a ram. In an alternative embodiment, the prefabricated structural element is connected to the film web, for example by sealing, and the depressions are then Conned in the film web.

As a rule, this packaging machine farther has an inserting station and a sealing station. According to the invention, a film web, in particular a plastic-film web, is conveyed cyclically along the packaging machine and, in a thermoforming station, first of ail a depression is formed in the film web, preferably by thermoforming. An article, preferably a foodstuff, is introduced into this depression. This depression, according to the invention, is connected to a structural element, this composite connection optionally taking place prior to or after insertion of the respective article into the insert, it being preferred for the article to be inserted once the composite connection has been made. Subsequently, in the sealing station, the insert is closed with a cover film, and the packs produced in this manner are finally singularized.

The packaging machine preferably has a conveying means which conveys prefabricated, preferably singularized structural elements to the connecting station. The conveying direction of said conveying means is preferably oriented, at least in part, parallel to the first conveying direction. The conveying means is, for example, a continuous belt which is arranged, in particular, below the conveying plane of the film web and runs in a plane which is parallel to the conveying direction of the film web. In a preferred embodiment, the film web and the conveying means are provided at a vertical angle to one another, i.e. the conveying means is inclined upward and/or the film web is inclined downward, such that they move toward one another. Alternatively or additionally, the film web and/or the conveying means are provided so as to be at least partially vertically displaceable. The film web and the structural element, in particular for mating, are moved briefly in relation to one another, the conveying means, in particular, being raised at least in part. The conveying means may move continuously or intermittently, a continuous movement being preferable. The conveying means is preferably synchronized with the movement of the film web. Further preferably, mating can take place when the film web is at a standstill or is moving. The extent of the conveying means in a direction transverse to its conveying direction corresponds preferably substantially to the width of the film web.

In another preferred embodiment, the conveying means comprises a transfer element, which receives singularized structural elements and conveys them, to the packaging machine. The transfer element preferably moves along a closed path. Said path is, for example, circular, elliptical, substantially rectangular or substantially square. The path preferably runs at least in part and/or temporarily, at least immediately prior to and/or at mating of the structural elements and the film web, preferably parallel or perpendicular to the conveying direction of the film web. The transfer element may move continuously or intermittently, a continuous movement being preferred. The transfer element is preferably synchronized with the movement of the film web. Further preferably mating can take place when the film web is at a standstill or is moving. The transfer element is, for example, a transfer wheel system or a paternoster system. The extent of the transfer means in a direction transverse to its conveying direction corresponds preferably substantially to the width of the film web or to about the length of a format.

The conveying means preferably comprises a robot, which receives, and conveys in the direction of the packaging machine, for example a transfer element, on which singularized structural elements are arranged.

The conveying means, or the transfer element, preferably has a means in which the respective structural elements are stored prior to connection to the film web. The conveying means and/or the conveying element are/is a tool, for example a counter-bearing, coring the operation of connecting the packaging depression to the structural element.

The packaging machine preferably has a means which conveys each transfer element along the conveying direction of the packaging depressions, for example from the connecting station to the filling station, in which the packaging depression is filled, or to the sealing station, in which the depression is closed with a cover. Thereafter, a robot retrieves the transfer means again.

According to a further or a preferred subject matter of the present invention, the packaging machine, for producing a structural element, has a means for the plastic deformation of the material web. This means forms the structural element in a planar material web from which the structural element is formed. The structural element is then preferably cut out of the material web. The film web and the material web are conveyed along the packaging machine preferably parallel to one another and, in particular, in a cyclically identical manner.

The observations made in the context of this subject matter of the present invention apply equally to the other subjects of the present invention, and vice versa.

The packaging machine preferably has a means for moistening and/or heating the material web for producing a structural element. On account of this, the plastic deformation of said structural element can at least be simplified and/or ruptures in the material web can be prevented. Moistening can take place, for example, by spraying and/or by vapor. The moistening means is preferably water. If applicable, the material web is dried after forming.

A further subject matter of the present invention is a method for producing a pack having a depression, which is thermoformed from a film web and is connected to a structural element, in which the structural element is connected to the film web prior to the packaging depression being thermoformed.

The observations made in the context of this subject matter of the present invention apply equally to the other subjects of the present invention, and vice versa.

According to the invention, the depression is formed in the material web only once the structural element has been connected to the film web. Connection takes place preferably integrally, for example by sealing or crimping. To this end, the film web, preferably on its side facing the structural element, has a sealing layer. The pack preferably has a periphery which is connected to the film web.

The film web is preferably heated simultaneously or subsequently, and the film web is then thermoformed to give the depressions. For this purpose, a vacuum is preferably applied between the structural element and the film web, and/or the film web is pushed into the structural element by means of a ram. The film web here can be brought to abut fully on the inner side of the structural element. The film web may, however, also be deformed such that it abuts only partially on the structural element.

In order to avoid an air cushion being formed between the film web and the structural element, either a vacuum is created there and/or the structural element is designed such that it is permeable to gas. To this end, the structural element may be produced from a permeable material and/or have openings through which air can evacuate when the film web is being thermoformed. The openings may be, for example, perforations, for example a micro-perforation or a macro-perforation, which the material has per se or which are/is incorporated subsequently.

In order to form an air cushion between the film web and the structural element, for example to produce and/or amplify a heat-insulating effect, either a vacuum limited, for example, by time and/or by volume is created or the structural element is designed such that it is permeable to gas. To this end, the structural element may be produced from a permeable material and/or have openings through which air can evacuate when the film web is being thermoformed. The openings may be, for example, perforations, for example a micro-perforation or a macro-perforation, which the material has per se or which are/is incorporated subsequently.

A further subject matter of the present invention is a method for producing a pack having a depression, which is thermoformed from a film web and is connected to a structural element, in which the film web and a material web from which the structural element is produced are thermoformed substantially simultaneously and/or in the same tool.

The observations made in the context of this subject matter of the present invention apply equally to the other subjects of the present invention, and vice versa.

According to this subject matter of the present invention, the film web and the material web are thermoformed substantially simultaneously and/or in the same tool. The integral connection between the film web and the structural element preferably takes place here, too.

Yet a further subject matter of the present invention is a method for producing a pack having a packaging depression, which is thermoformed from a film web and is connected to a structural element, in which, for thermoforming the film web, a vacuum is provided between the film web and the structural element.

The observations made in the context of this subject matter of the present invention apply equally to the other subjects of the present invention, and vice versa.

On account of the vacuum, i.e. the negative pressure between the film web and the structural element, it is possible for the film web to deform such that at least part of it lies closely against the inner side of the structural element. Moreover, an air cushion between the film web and the structural element can be avoided on account of the vacuum.

A further subject matter of the present invention is a pack having a depression, made of a film material and connected to a structural element, wherein the structural element has a perforation and/or is at least partially produced from a gas-permeable material.

The observations made in the context of this subject matter of the present invention apply equally to the other subjects of the present invention, and vice versa.

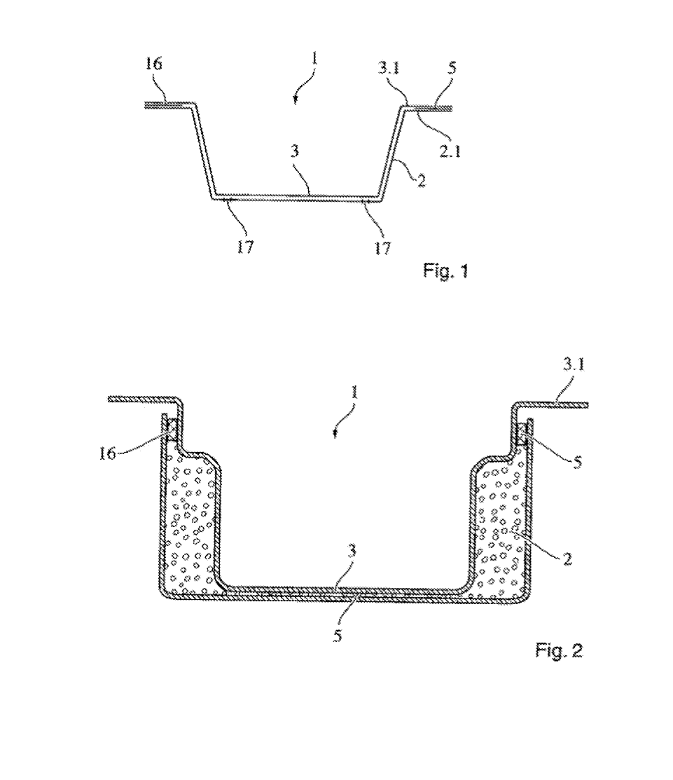

The invention is explained in the following by means of figures 1 to 8. These explanations are merely by way of example and do not limit the general concept of the invention. The explanations apply equally to ail the subjects of the present invention.

FIG. 1 shows a first embodiment of the packaging depression to be produced,

FIG. 2 shows a second embodiment of the

packaging depression to be produced,

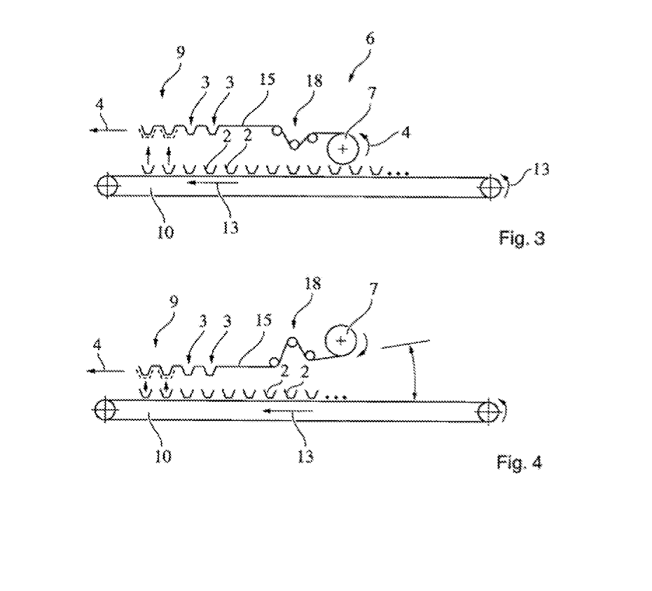

FIGS. 3 to 9 each show an embodiment of the packaging machine according to the invention.

FIG. 1 shows an example of a packaging depression 1 which can be produced by the packaging machine according to the invention. This packaging depression 1 has a structural element 2, which extends, at least substantially, around the entire circumference of a thermoformed depression 3, which has been formed from a plastic-film web. This structural element has a wail portion which tapers toward the base of the structural element. This depression and the structural element, which is preferably an element having paper, paperboard and/or cardboard, are in particular integrally connected to one another at one or more connection points 5. These connection points are situated here between a periphery 2.1 of the structural element 2 and a periphery 3.1 of the depression. On account of the periphery 2.1 on the structural element 2, the structural element 2 can be connected to the film web prior to the depression 2 being formed in the film web. The structural element 2 may be, for example, folded or thermoformed. The structural element 2 furthermore has a perforation 17, in order for it to be possible to build up a vacuum between the film web and the structural element and/or to avoid the formation of a gas cushion during deformation with a ram. The perforation 17 may be a micro-perforation and/or a macro-perforation. This perforation may already be present in the material from which the structural element is produced, and/or it may be introduced subsequently into said structural element (prior to thermoforming).

FIG. 2 snows a further embodiment of a pack. In this case, the connection 5 between the depression 3 and the structural element 2 takes place at the side wail and the base. Besides this, a gas cushion, which acts as heat insulation, is provided in part between the depression 3 and the structural element 2.

FIG. 3 shows a first embodiment of the packaging machine 6 according to the invention. This packaging machine is what is referred to as a Form-Fill-Seal machine, in which a film web 15 is unrolled from a film roll 7 and conveyed cyclically along the packaging machine, as symbolized by the arrow 4. In each cycle, a format composed X-Y units is simultaneously conveyed and simultaneously processed. In a first step, in each cycle in each case X-Y depressions 3 are formed in the film web, in particular by thermoforming. Thereafter, this format composed of X-Y depressions is conveyed cyclically onward until it reaches the connecting station 9. Here, the depressions 3 are each connected to a structural element 2, here a cardboard structure. In this process step, the depressions 3 are at a standstill or the depressions are moving. For connecting the depressions 3 to the structural elements 2, the latter first of all, from a position which is remote from the packaging machine, are positioned by a conveying means 10, here a continuous belt, below the respective depression 3 and positioned, for example, in a plate, which here has X-Y indentations. The structural elements 2 here already have their three-dimensional shape. Thereafter, the structural elements 2 are simultaneously raised and pushed over the depressions 3, until they have reached their desired end position in relation to the depression 3. Subsequently, the integral connection between in each case one depression 3 and one cardboard structure 2 takes place. A person skilled in the art recognizes that it is also possible to raise the conveying means in its entirety or in part. This can take place, for example, in that sealing jaws are pushed from the inside against the insert 3 and, on account of this, connect the insert 3 to the structural element 2. According to the invention, then, it is provided that the movement direction 4 of the film web 15 and the conveying direction 13 of the conveying means 10 run parallel to one another. In the present case, both movements 4, 13 are provided so as to be parallel to the paper plane. Thereafter, the depressions and the cardboard structures, which are now connected to one another, are cyclically conveyed to an inserting station (not illustrated), in which each packaging depression 1 is filled with an article. Subsequently, the thus completed packaging depression is closed with a cover in the sealing station (not illustrated), said cover preferably being sealed at a sealing periphery under the influence of pressure and/or temperature. Prior to and/or during the operations of closing the packaging depression, a gas exchange may take place in the packaging depression. The cover film may be what is referred to as a skin film. Subsequently, the thus completed packs are singularized. in a singularizing station (not illustrated) by the plastic-film web, from which the depressions 3 have been produced, and the cover-film web being cut out around the depressions.

FIG. 4 substantially shows the embodiment of the packaging machine according to FIG. 3, the conveying plane of the film web 15 in the present case running obliquely, at an angle α, in relation to the conveying means. On account of this, the distance between the depressions 3 and the structural elements 2 is reduced and these can be connected to one another.

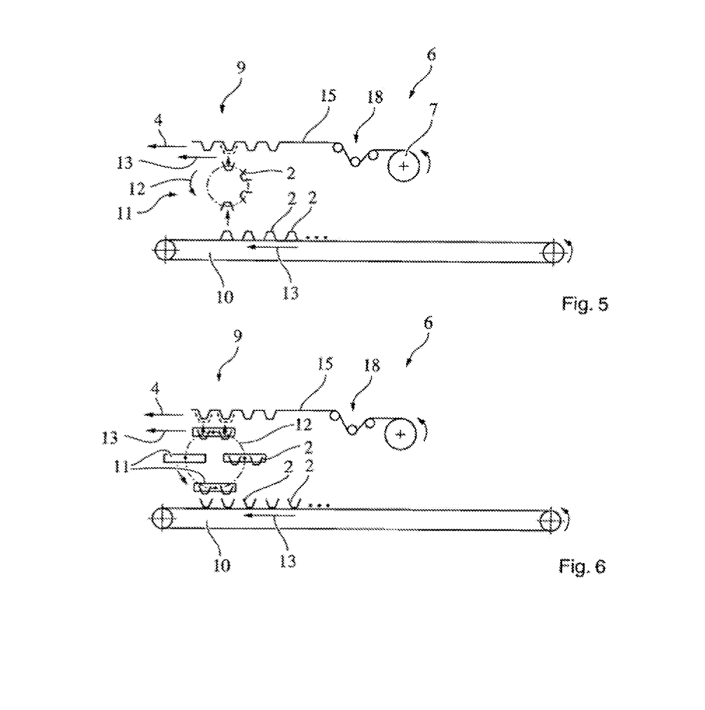

FIG. 5 shows a further embodiment of the packaging machine according to the invention, reference again being made to the observations according to FIG. 3. In the present case, a transfer element 11, which receives the structural elements 2 from the conveying means 10 and places them below the film web, is provided between the conveying means 10 and the film web 15. The transfer element here is a transfer drum which, on its surface, has a multiplicity of indentations which can, at least in part, receive a structural element. A plurality of indentations are preferably provided next to one another, as seen in relation to the longitudinal axis of the drum. The width of the drum preferably corresponds to the respective width of the film, perpendicular to its conveying direction. A negative pressure may be applied to portions of the indentations of the drum in order to attach the structural elements to the drum, in order to thermoform the film web and/or in order to implement an integral connection between the film web and the structural element. As illustrated by the arrow 13, the movement of the transfer element 11, at least in the region of the 12 o'clock position, is parallel to the conveying direction 4 of the film web. The drum may rotate continuously or intermittently. The connection of the structural elements 2 to the film web 15 takes place preferably during advancement of the same. The movement of the film web and of the drum 11 axe preferably synchronized. The drum 11 may serve as a tool, for example as at counter-bearing daring the operation of connecting the film web 15 to the structural element 2.

FIG. 6 substantially shows the embodiment of the packaging machine according to FIG. 5, the conveying means in the present case being a paternoster system having transfer elements 11 which move, preferably continuously, along a closed path 12 and convey the structural elements 2 from a conveying belt toward the film web 15. In the present case, the operation of connecting the structural elements 2 to the film web 15 takes place while said film web 15 is at a standstill. In any other respect, reference may be made to the observations in relation to FIG. 5. A person skilled in the art understands that the conveying direction of the paternoster system may also run transversely to the conveying direction 4 of the film web, that is to say rotated by 90° in relation to the illustrated direction. The width of the paternoster system transverse to its conveying direction then corresponds preferably substantially to the length of a format.

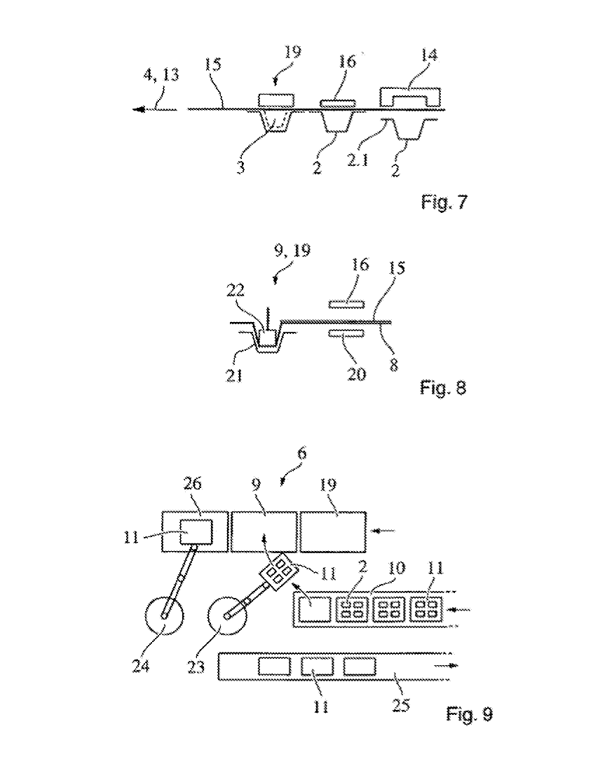

FIG. 7 shows an embodiment of the present invention in which a structural element 2, with a periphery 2.1, is fixed by a tool 14, for example by sealing or crimping, on a planar film web 15. Thereafter or simultaneously, a heating means 16 heats the film web, and in a next step, in a forming station/connecting station, the depression 3 is formed in the structural element 2, and connected thereto, here by thermoforming by means of a vacuum. In any other respect, reference is made to the observations in relation to the other figures.

FIG. 3 shows an embodiment in which a film web 15 and a material web 3 are thermoformed simultaneously and/or in one tool 21, 22. The depression 3 is formed from the film web 15, and the structural element 2 is formed with the material web 8. For plastic deformation of the film web, the latter is preferably heated by a heater 16. Depending on requirements, the material web 8 is likewise heated and/or moistened, in order to improve its deformation properties. Thereafter, thermoforming preferably takes place with a ram 22 and/or a cavity 21, and optionally under the action of a vacuum. In any other respect, reference is made to the observations in relation to the other figures.

FIG. 9 shows a further embodiment of the present invention. The transfer element 11, in the present case, is a loose element, i.e. it is not fixedly connected to any specific device but can be transferred from one device to another. Each transfer element 11 is configured, for example, as a frame which has at least one recess, into which one or more structural element(s) 2, for example board trays, are inserted. The structural elements 2 are provided in a preferably singularized manner in the frame. The transfer elements filled with structural elements are conveyed, for example by a conveying belt 10, in the direction of the connecting station 9 of the packaging machine 6. There, the transfer elements are each received by a robot 23, which inserts them into the connecting station. The transfer elements here are preferably placed below a film-conveying plane. At this point in time, a multiplicity of depressions, each connected to a structural element 2, are formed in the film. The packaging machine preferably has a conveying mechanism with which the transfer element which has been transferred by the robot can be conveyed along the packaging machine at least up to the next station, for example up to the filling station or the sealing station. On account of this, the transfer element can be conveyed together with the depressions/structural elements and, in the filling station or sealing station, can serve as a supporting tool and/or as a counter-bearing for a sealing tool. In the present case, the transfer element 11 is picked up again by a second robot 24 in a station 26 of the packaging machine, said station being provided downstream of the connecting station, and is removed from said station and transferred to a further conveying belt 25, which conveys away the transfer elements for refilling. The conveying means 10, 25 are preferably arranged above one another. A person skilled in the art recognizes that one robot may also suffice in order to accomplish the transfer and retrieval of the transfer elements 11. It is also possible for the transfer elements to be removed directly again from the connecting station. In this case, it is advantageous if the second robot is at the opposite side of the packaging machine 6. A person skilled in the art recognizes that the transfer elements and/or the structural elements can also be transferred to the forming station. In this case, the depression is formed in, and connected to, the reinforcing element.

### LIST OF REFERENCE SIGNS

1 Packaging depression
2 Structural element, outer cardboard structure
2.1 Periphery of the structural element 2
3 Depression made of film, in particular plastic film
3.1 Periphery of the depression 3
4 Conveying direction of the film web
5 Connection point, welding face, sealing face
6 Packaging machine
7 Film roll
8 Material web for producing the structural element 2, cardboard material web
9 Connecting station
10 Conveying means, conveying belt, transfer drum, paternoster
11 Transfer element

### 12 Path

13 Conveying direction, second conveying direction
14 Sealing tool, upper sealing tool

### 15 Film web

16 Heating means
17 Perforation, opening
18 Dancer roller
19 Forming station
20 Heating means and/or moistening means
21 Mold, lower mold
22 Mold, upper mold
23 Robot, handling unit
24 Robot, handling unit
25 Removal of empty transfer elements; conveying belt
26 Station downstream of the connecting station
α Vertical angle

1. A packaging machine in which a film web is intermittently conveyed along a first conveying direction, depressions being formed in the film web, and said depressions each being connected to a structural element in a connecting station,
wherein the structural elements are conveyed along a second conveying direction,
wherein the first and second conveying directions, in the region of the connecting station, are provided substantially parallel to one another, and a conveying means, which conveys the structural elements to the connecting station, is provided, characterized in that the conveying means is a continuous belt and the film web and the conveying belt are provided at an angle to one another and/or the continuous belt is provided so as to be at least partially vertically displaceable.

2-14. (canceled)

15. The packaging machine as claimed in claim 1, wherein the conveying means comprises a transfer means which has at least one transfer element, which receives singularized structural elements and moves preferably along a closed path.

16. The packaging machine as claimed in claim 15, wherein the conveying means comprises at least one robot, which conveys at least one transfer element, which receives singularized structural elements.

17. The packaging machine as claimed in claim 1, wherein the conveying means and/or the conveying element are/is a tool during the operation of connecting the packaging depression to the structural element.

18. The packaging machine as claimed in claim 1, wherein the conveying means conveys the transfer elements.

19. The packaging machine as claimed in claim 1, wherein packaging machine, for producing the structural element, has a means for the plastic deformation of the material web.

20. The packaging machine as claimed in claim 15, wherein the packaging machine has a means for moistening and/or heating the material web for producing the structural element.

21. The packaging machine as claimed in claim 16, wherein the packaging machine has a means for moistening and/or heating the material web for producing the structural element.

22. The packaging machine as claimed in claim 1, wherein the conveying means and/or the conveying element are/is a tool during the operation of connecting the packaging depression to the structural element.

23. A method for producing a pack having a packaging depression, which is thermoformed from a film web and is connected to a structural element, wherein the structural element is connected to the film web prior to the packaging depression being thermoformed.

24. The method for producing a pack having a packaging depression of claim 23, wherein the film web and a material web from which the structural element is produced are thermoformed substantially simultaneously and/or in the same tool.

25. The method for producing a pack having a packaging depression of claim 23, wherein thermoforming the film web, a vacuum is provided between the film web and the structural element.

26. A pack having a depression, made of a film material and connected to a structural element, wherein the structural element has a perforation or is at least partially produced from a gas-permeable material.
